(19) United States
(12) Patent Application Publication
(10) Pub. No.: US 2025/0219571 A1
(43) Pub. Date: Jul. 3, 2025

(54) Prefabricated Solar Panel Roof Section

(71) Applicant: Raymond Solar AB, Mölnlycke (SE)

(72) Inventor: Mattias HANSSON, Mölnlycke (SE)

(21) Appl. No.: 18/851,874

(22) PCT Filed: Mar. 30, 2023
(86) PCT No.: PCT/EP2023/058347

§ 371 Date: Sep. 27, 2024

(30) Foreign Application Priority Data
Mar. 30, 2022 (SE) 2250393-2

(51) Int. Cl. H02S 20/23

(52) U.S. Cl. CPC H02S 20/23

(57) ABSTRACT

An assembly for mounting a solar panel roof comprises a plurality of screws and at least one prefabricated multi-panel solar roof section including a plurality of supporting joists. A plurality of solar panels is arranged in columns. The solar panels in each column partly overlap along edges perpendicular to the joists. At least one elongated fixation element is arranged along each joist supporting two adjacent solar panels. Each fixation element has two flanges resting against a respective one of the adjacent solar panels. Each fixation element is further provided with a set of holes. Each hole has a diameter greater than the screw head, thereby allowing securing the joists to a roof by fastening the screws through the holes.

### TECHNICAL FIELD OF THE INVENTION

The present invention relates to a solar panel roof system. The invention is particularly (but not exclusively) useful for so called integrated solar panel roofs.

### BACKGROUND OF THE INVENTION

With the increasing interest in solar energy, it has become increasingly popular to arrange solar panels on the roofs of houses, including private homes. By providing a private home with solar panels (rectangular elements covered by solar cells) on at least a portion of the roof surface, the homeowner may generate electricity for personal use as well as for delivery onto the electrical grid. Some governments provide tax incentives for installing such solar panel installations, and also incentivize the delivery of solar power into the national grid.

In many cases, the solar panels are mounted on top of a weather protecting surface of the existing roof. Such a weather protecting surface may be tar paper, sheet metal, or tiles. Such a “retrofit” installation of solar panels typically involves attaching suitable mounting brackets, onto which the solar panels are then mounted. The mounting brackets need to be attached without jeopardizing the weather protection of the roof. There is typically a separation between the original roof and the solar panels, enabling air to circulate and cool the underside of the panels.

In other cases, solar panels are installed when building a new house, or when replacing the roof (for example, roof tiles typically have a life span of about 30 years and then need to be replaced). For this purpose, there are commercially available solar panels which can serve not only as solar cells, but also as the weather protection of the roof. One example of such solar panels sold by Gruppsol AB, are shown at www.gruppsol.com. A roof construction where at least part of the weather protective outer layer is formed of solar panels is sometimes referred to as “integrated” solar panels. This is a potentially cost-efficient approach, with one roof covering layer instead of two.

There is a constant strive for improvements in solar panel roof systems, regardless of whether the panels are “retrofitted” or part of an integrated solar panel roof.

Document WO2021/096417 provides an example of a solar panel roof, which is easy to mount and which provides an improved structural strength.

However, a potential drawback with existing solar panel roof systems is that the mounting of individual solar panels is difficult and time consuming. Another issue is that each panel needs to be individually electrically connected. It would therefore be highly beneficial to prefabricate entire roofs, or at least multi-panel sections of a roof in an assembly site, and then mount the prefabricated sections on the house. Only one electrical connection will be required of each such multi-panel section.

To date, there are no viable solutions for such prefabrication and mounting of multi-panel roof sections.

### SUMMARY OF THE INVENTION

It is an object of the present invention to provide a prefabricated multi-panel solar roof section which may be transported to a construction site and mounted to an existing roof.

This and other objects are achieved by an assembly for mounting a solar panel roof, comprising a plurality of screws, each screw having a screw head, and at least one prefabricated multi-panel solar roof section including a plurality of supporting joists arranged in parallel, at a predefined c-c distance, a plurality of solar panels arranged in columns, each column including a plurality of solar panels supported by and bridging a distance between two adjacent joists, wherein the solar panels in each columns partly overlap along edges perpendicular to the joists, and at least one elongated fixation element arranged along each joist supporting two adjacent solar panels, each fixation element having two flanges resting against a respective one of the adjacent solar panels, the fixation element serving to fixate the adjacent solar panels. Each fixation element is further provided with a set of holes, each hole having a diameter greater than the screw head, thereby allowing securing the joists to a roof by fastening the screws through the holes.

As the screw holes are larger than the screw head diameter, the screws may be inserted from above, and used to fixate the joist to an underlying surface such as a roof. The holes may then be sealed by a suitable plug, to maintain weather durability.

The fixation elements may have a length corresponding to one solar panel, or may extend along several panels, possibly along the entire section. In the former case, the flanges of each fixation element rest tightly against the upper side of two adjacent panels. In the latter case, a long fixation element will extend across the step formed by the partial overlap of two solar panels. This may require additional efforts to ensure sealing. The flanges of each fixation element may be provided with a compressible sealing layer facing the solar panels

Adjacent columns may be separated by a gap along a central axis of a supporting joist, and each fixation element can then have a T-section with a central web positioned in the gap between two adjacent solar panels. This further improves reliability in when assembling the solar panel roof section.

Each joist may be provided with a trench on each side, such that any water penetrating between a solar panel and the joist will be collected in the trench and guided down along the joist. Such trenches may be formed by a trench forming element (e.g. made of rubber material such as EPDM) arranged on the upper side of each joist.

According to a second aspect of the invention, the above object is achieved by a method for mounting a prefabricated multi-panel solar roof section on a roof, the prefabricated multi-panel solar roof section including, a plurality of supporting joists arranged in parallel, at a predefined c-c distance, a plurality of solar panels arranged in columns, each column including a plurality of solar panels supported by and bridging a distance between two adjacent joists, wherein the solar panels in each columns partly overlap along edges perpendicular to the joists, and at least one elongated fixation element arranged on each joist, each fixation element having two flanges resting against a respective one of the adjacent solar panels, the fixation element serving to fixate the adjacent solar panels. The method includes attaching a lifting frame to the solar panel roof section using screws extending through the holes and into the joists, lifting the solar panel roof section onto a desired location on the roof using the lifting frame, removing the lifting frame by unscrewing the screws, securing the solar panel roof section to the roof using screws extending through the holes, through the joists and into the roof.

### BRIEF DESCRIPTION OF THE DRAWINGS

The present invention will be described in more detail with reference to the appended drawings, showing currently preferred embodiments of the invention.

FIG. 1 shows schematically a house provided with a solar panel system.

FIG. 2 shows a prefabricated solar roof section formed by four solar panels mounted on joists, according to an embodiment of the invention.

FIG. 3 shows a cross section of the profile edging in FIG. 2.

FIG. 4 shows a cross section of two solar panels resting on a joist.

FIG. 5 shows a lifting frame mounted to the solar roof section in FIG. 2.

FIG. 6 shows the solar roof section in FIG. 2 arranged on a roof.

FIG. 7 is a flow chart of a method for mounting a solar roof section according to an embodiment of the invention.

### DETAILED DESCRIPTION OF CURRENTLY PREFERRED EMBODIMENTS

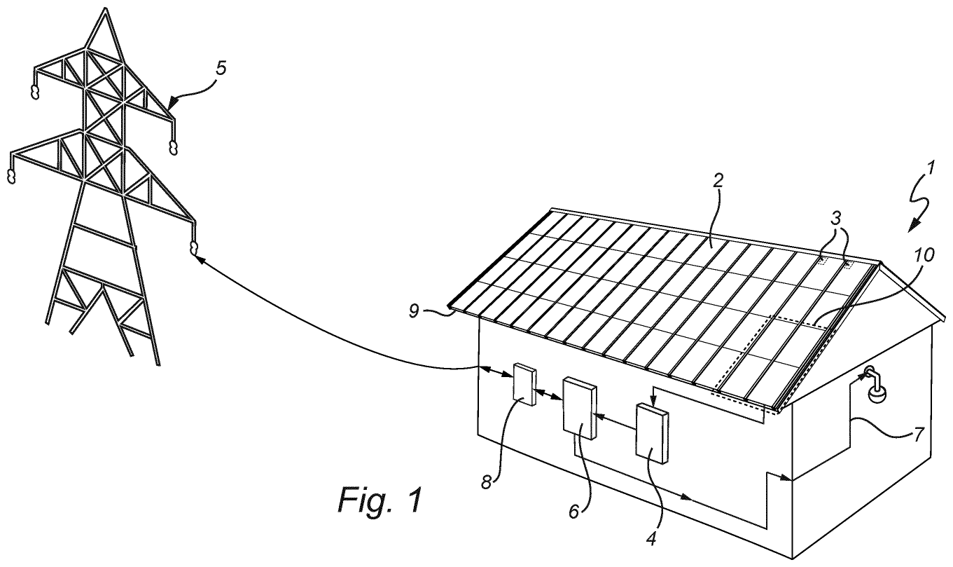

FIG. 1 shows a house 1 provided with solar panels 2 including solar cells which generate electricity when exposed to sunlight. As shown in FIG. 1, the solar panels cover substantially the entire roof, but it is equally possible to combine the integrated solar panels with conventional tiling.

The solar cells are electrically connected to a power inverter 4 which is configured to convert the generated DC power to AC power compatible with the requirements of the local electrical power grid 5. The inverter 4 is connected to a main controller 6 which is also connected to the electrical system 7 of the house 1 and to the grid 5. The controller is configured to provide the electrical system of the house with electrical power from the solar panels 2 when such power is available, and otherwise to provide electrical power from the grid 5. The system also includes a monitoring/metering unit 8, which measures how much power from the solar panels 2 that is output to the grid 7, and also how much power that is drawn from the grid 5. Additionally, the inverter 4 may be connected to a high-power battery device 9, in order to store electrical energy for future personal use instead of outputting in to the grid 5.

In FIG. 1, the inverter 4 is a single unit, in which case all solar panels are connected in series to the single inverter 4. Such a single inverter is sometimes referred to as a “string inverter”. Each panel may be provided with a power optimizer 3, which, as the name implies, is configured to condition the generation of electrical power in the particular solar panel to optimally fit with the operation of the string inverter 4. The controller 6 is then connected to control each power optimizer 3.

Alternatively, each solar panel is provided with a separate inverter, sometimes referred to as a “microinverter”. Although more expensive, this may be more efficient, especially if the panels are partly shaded, or mounted at different angles toward the sun.

Power optimizers and microinverters, i.e. power electronics arranged in association with each solar panel, are sometimes referred to as “module-level power electronics”, or MLPE.

The solar panel roof in FIG. 1 is integrated. An integrated solar panel roof is here understood to provide a combined function of solar cells and outer protection (against weather, pressure, wear, etc.) of the roof. In other words, when installing an integrated solar panel roof, no regular roof tiling is required in areas where the solar panels are located. Such integrated solar panels are commercially available, e.g. from Gruppsol AB. In this case, each solar panel comprises a solar cell grid sandwiched between two glass panels. The glass is preferably temperated (safety) glass to provide a structurally strong surface. The panels may be 1 m by 1.65 m, but other dimensions are of course possible.

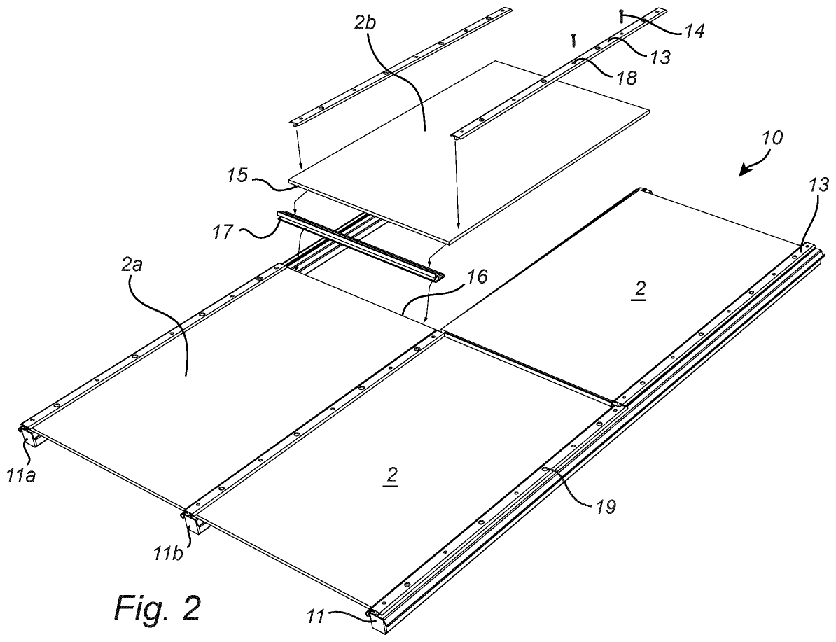

FIG. 2 shows a prefabricated section 10 of the integrated solar panel roof in FIG. 1, here with three joists 11 and four solar panels 2, arranged in two columns 12.

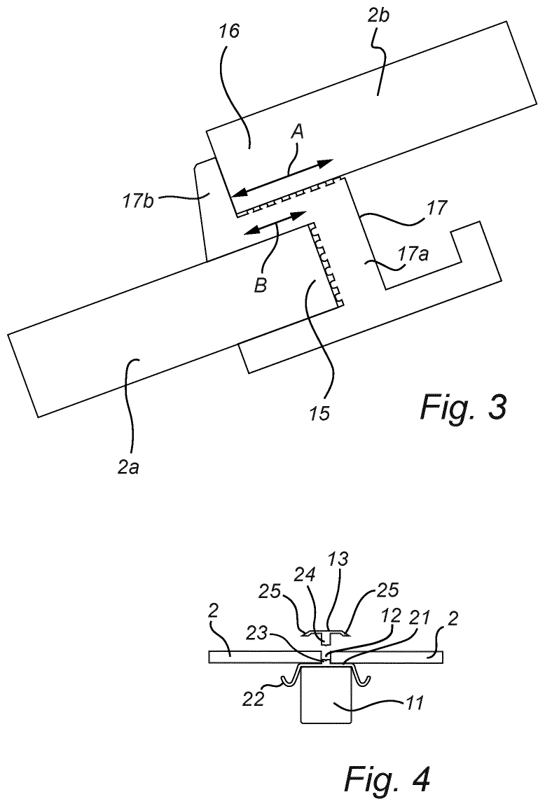

The joists 11 are arranged at a center-to-center (cc) distance based on the width of the solar panels 2 that are to be mounted thereon. As shown more clearly in FIG. 3, the cc-distance is here slightly larger than the panel width, so as to leave a gap 12 between adjacent panels (see FIG. 3). The panels 2 are held in place by elongated fixation elements 13, which are aligned with the joists and mounted on top of the panels 2. The length of the element 13 here corresponds to the length of one solar panel 2. In an alternative embodiment, one single fixation element covers several panels 2, possibly an entire column. The elements 13 are fasted by suitable fixation means, e.g. screws 14, extedning through holes 18. Each fixation element is further provided with a second set of holes 19, which will be discussed in more detail below.

The panels 2 rest on a compressible sealing layer (not shown) provided on the upper side of each joist 11. The sealing layer may be made of a rubber material, e.g. EPDM. In addition to providing a water sealing, the sealing layer may also provide shock absorption protecting the panels.

The solar panels 2a, 2b in a column rest against the upper surfaces of two adjacent joists 11a, 11b, such that the panels 2a, 2b bridge the space between the joists 11a, 11b. The panel 2a is intended to be located closer to an edge 9 of the roof. The panel 2b is mounted such that an edge 15 of panel 2b protrudes over an edge 16 of panel 2a.

A rubber edging 17 is mounted along edge 15, in order to provide a sealing function between the panels, and also to provide additional support for panel 2b. The edging 17 may be made of extruded rubber, e.g. EPDM. The arrangement of the edging 17 with resepct to the panels 2a and 2b is shown more clearly in FIG. 3.

As shown in FIG. 3, the edging 17 has a U-shaped portion 17a, and an abutment portion 17b extending from an upper surface of the edging. The innermost surface of the U-shaped portion 17a and the upper surface may be provided with parallel ridges extending along the entire length of the profile.

The U-shaped portion is configured to fit tightly around the upper edge 15 of a lower panel 2a, such that the edge 15 is pressed against the ridges. The lower edge 16 of the upper panel 2b rests on the ridges on the upper surface of the edging 17, and also against the abutment 17b.

During installation, the abutment 17b will facilitate a correct positioning of the upper panel 2b. When installed, the edging 17 will provide sealing between the upper and lower panels 2a, 2b, preventing water to enter under the solar panels. The ridges will improve the sealing effect of the edging 17.

The height of the abutment 17b is preferably smaller than the thickness of a solar panel 2. This prevents water running over the edge 16 of the the upper panel 2b from entering between the edging 17 and the edge 16.

However, the height of the abutment 17 is still sufficiently large that, in a situation where the lower panel 2a “sags” so that the upper edge 16 of the upper panel no longer is in contact with the upper surface of the edging, the abutment 17b will still provide a sealing effect.

It is also clear from FIG. 3 that the edging 17 provides an extension of the lower panel 2a. As a result, the area of contact A between the edging 17 and the upper panel 2b will be larger than the actual overlap B of the panels 2a, 2b. This is beneficial, as a too large overlap will risk shading the solar cells on the panels.

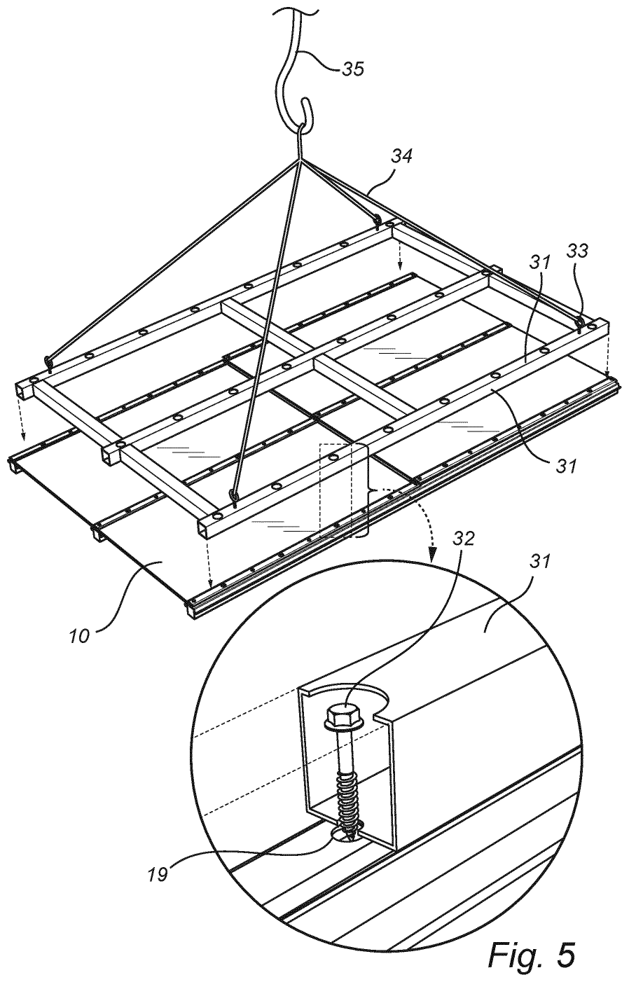

Turning to FIG. 4, the section 10 may also include trench forming elements 21 forming trenches 22 on either side of the joist 11. These trenches will serve to guide any water penetrating the edge of a panel down towards the lower edge 9 of the roof. The element 21 may also have a centrally located protruding ridge 23. This ridge 23 will extend at least partially into the gap 12 formed between two adjacent panels. During mounting of the panels, such a ridge 23 will serve as a guide, to facilitate the arrangement of solar panels 2 onto the joists 11.

The fixation element 13 is also shown in more detail in FIG. 3, and here has a T-profile with a central web 24 and two flanges 25. The element 13 is arranged such that the web 24 extends down into the gap between two adjacent solar panels, and towards the protrusion 23. The flanges 25 press against a respective one of the adjacent solar panels 2.

If the fixation elements 13 are made of a rigid material such as aluminum or hard plastic, the sides facing the solar panels 2 may be provided with a compressible sealing layer (not shown) to ensure water resistance.

With a design like in FIG. 2-4, the prefabricated solar panel roof section 10 is highly weather resistant. In the event water does penetrate the edges of the panels 2, such water can follow the trenches 22 out of the roof system.

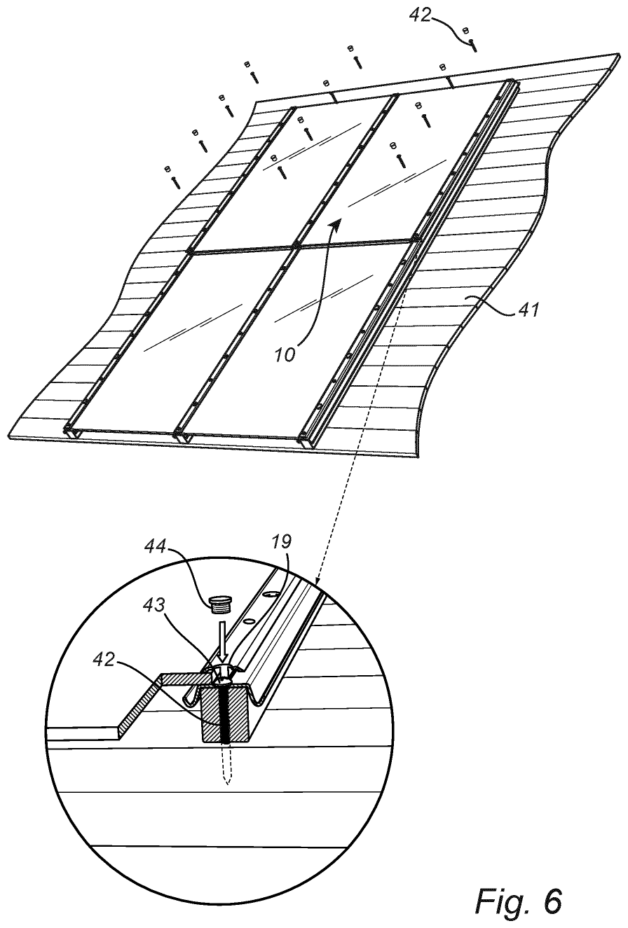

FIG. 5 illustrates how the prefabricated roof section 10 can be lifted, e.g. in connection with transport or mounting on a roof.

As the roof section 10 is not yet mounted to a roof, the joists 11 are easily accessible through the holes 19. This allows attaching a structure, such as a lifting frame 31, to the section 10 using screws 32. This is illustrated more clearly in the enlargement in FIG. 5, where the frame 31 is shown as constructed of metal beams with a rectangular cross section. The beam has an upper hole, which is larger than the head of the screw 32, and a bottom hole which is located immediately above a hole 19 in the prefabricated section 10. The screw 32 may thus be screwed through the hole 19 and fasten the frame 31 to the section 10.

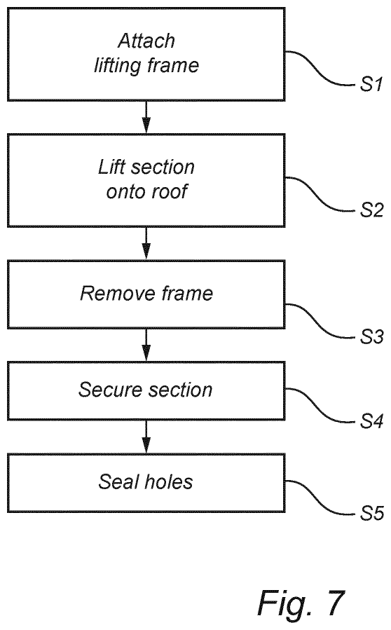

The lifting frame 31 may be provided with hooks 33 or similar means for attaching lifting ropes 34 or the like to allow lifting the section 10 with e.g. a crane 35. The prefabricated roof section 10 may thus be lifted onto a transport vehicle for transport to a construction site, and also lifted into its desired position on a roof 41, as shown in FIG. 6. The section 10 is preferably held in place by suitable support structure, e.g. a wooden joist (not shown) temporarily fixed to the roof 41.

When the roof section 10 is in pace, the lifting frame can be removed by unscrewing the screws 32. The holes 19 may now be used to secure the roof section 10 to the roof 41. For this purpose, screws 42 are used. The screws 42 are longer than the thickness of the joists 11, and have screw heads 43 which are smaller in diameter than the holes 19. The screws can therefore be screwed through the holes 19, though the joists 11, and into the roof 41. The head of the screw head 43 will pass through the hole 19 and abut against the upper side of the joist 11. The screw 42 will thus serve to secure the joist 11 to the roof 41. After the screws 42 have been tightly fastened, the holes 19 may be sealed using sealing plug 44 made of a suitable material such as rubber, and configured to tightly fit into the holes 19.

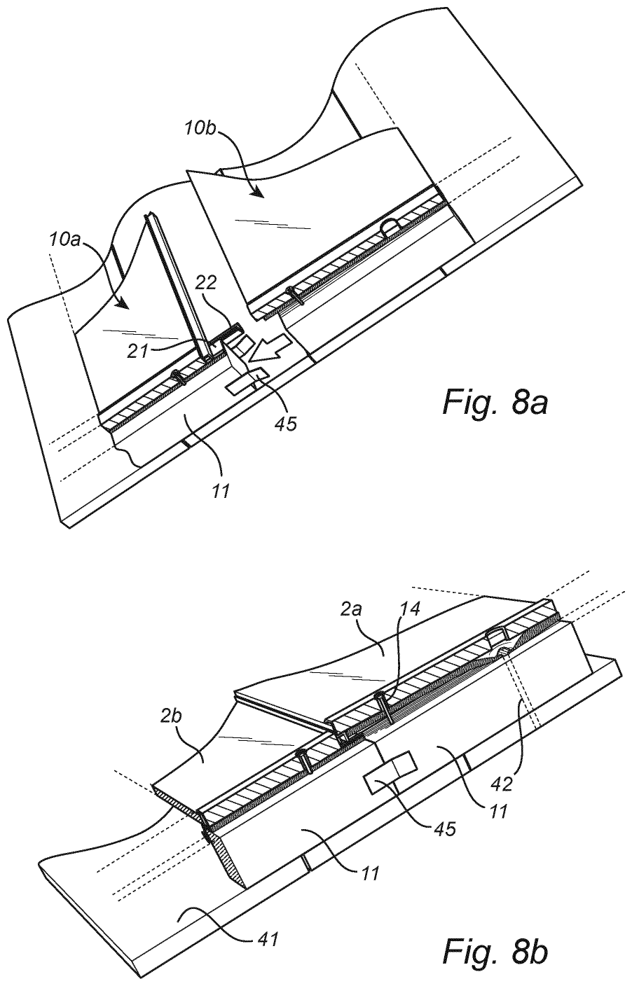

The method of mounting a prefabricated solar roof section can thus be described by the following steps, as shown in FIG. 7:

First, in step S1, a lifting frame 31 is mounted to the section 10 using screws 32. Then, in step S2, the frame 31 and section 10 are transported and lifted into a desired location on a roof 41. In the next step S3, the lifting frame is removed by unscrewing the screws 32. The section 10 is then secured to the roof 41 using screws 42. Finally, in step S5, the holes 19 are sealed using sealing plugs 44.

In FIG. 8a a first prefabricated solar roof section 10a has been mounted on a supporting roof 41, and a second roof section 10b is being mounted. The joists 11 are here provided with guiding brackets 45, to assist in guiding the joists of the second solar panel roof section 10b in alignment with the first section 10a.

As shown in FIG. 8a, the trench forming element 21 has been cut, so that the trenches 22 protrude towards the second section 10b. As a consequence, the trenches of the second section 10b overlap the trenches of the first section 10a, ensuring that there is no leakage in the interface between sections.

As shown in FIG. 8b, some of the screws 14 securing the solar panels to the joists 11, may be not fully screwed into the joists, so as to allow a distance between the panel 2 and the joist 11. This distance will allow an overlap of the lower solar panels 2b of the second section 10b with respect to the upper solar panels 2b of the first section 10a.

When the second section 10b is aligned with, and rests against, the first section 10a, it is secured with screws 42 as described above.

The person skilled in the art realizes that the present invention by no means is limited to the preferred embodiments described above. On the contrary, many modifications and variations are possible within the scope of the appended claims. For example, the number of solar panels in each section may be different than four. Additional sealing elements may also be provided to even further improve weather durability.

1-11. (canceled)

12. An assembly for mounting a solar panel roof, comprising:
a plurality of screws, each screw having a screw head; and
at least one prefabricated multi-panel solar roof section including:
a plurality of supporting joists arranged in parallel, at a predefined c-c distance,
a plurality of solar panels arranged in columns, each column including a plurality of solar panels supported by and bridging a distance between two adjacent joists, wherein the solar panels in each columns partly overlap along edges perpendicular to the joists, and
at least one elongated fixation element arranged along each joist supporting two adjacent solar panels, each fixation element having two flanges resting against a respective one of the adjacent solar panels, said fixation element serving to fixate the adjacent solar panels;
wherein each fixation element is provided with a set of holes, each hole having a diameter greater than said screw head, thereby allowing securing said joists to a roof by fastening said screws through said holes.

13. The assembly according to claim 12, wherein each fixation element has a length corresponding to one solar panel.

14. The assembly according to claim 12, wherein each flange of the fixation element is provided with a compressible sealing layer facing the solar panels.

15. The assembly according to claim 14, wherein the compressible sealing layers are made of rubber material, such as EPDM.

16. The assembly according to claim 12, wherein adjacent solar panels in adjacent columns are separated by a gap along a central axis of a supporting joist, and wherein each fixation element has a T-section with a central web positioned in the gap between two adjacent solar panels.

17. The assembly according to claim 12, wherein each joist is provided with a trench on each side, such that any water penetrating between a solar panel and the joist will be collected in said trench and guided down along the joist.

18. The assembly according to claim 17, wherein said trenches are formed by a trench forming element arranged on the upper side of each joist.

19. The assembly according to claim 12, wherein each solar panel comprises a solar cell array sandwiched between two sheets of glass.

20. The assembly according to claim 12, further comprising a set of sealing plugs, configured to fit tightly into said holes when said solar roof section is secured to a roof, thereby preventing water from entering into said hole.

21. A method for mounting a prefabricated multi-panel solar roof section on a roof, the prefabricated multi-panel solar roof section including,
a plurality of supporting joists arranged in parallel, at a predefined c-c distance,
a plurality of solar panels arranged in columns, each column including a plurality of solar panels supported by and bridging a distance between two adjacent joists, wherein the solar panels in each columns partly overlap along edges perpendicular to the joists, and
at least one elongated fixation element arranged on each joist, each fixation element having two flanges resting against a respective one of the adjacent solar panels, said fixation element serving to fixate the adjacent solar panels;
the method comprising:
attaching a lifting frame to the solar panel roof section using first screws extending through holes in the fixation elements and into the joists;
lifting the solar panel roof section onto a desired location on the roof using the lifting frame;
removing the lifting frame by unscrewing the first screws;
securing the solar panel roof section to the roof using second screws extending through the holes, through the joists and into the roof, said second screws having screw heads with a diameter smaller than a diameter of said holes, such that the screw heads pass through the holes.

22. The method according to claim 21, further comprising sealing the holes with sealing plugs.
